(19) United States
(12) Patent Application Publication
(10) Pub. No.: US 2024/0084517 A1
(43) Pub. Date: Mar. 14, 2024

(54) CLAMP ASSEMBLY

(71) Applicant: Transportation IP Holdings, LLC, Norwalk, CT (US)

(72) Inventors: Michael VanderLinden, Knoxville, IA (US); Mark Bachman, Albia, IA (US); Norman Wellings, Agency, IA (US)

(21) Appl. No.: 18/365,103

(22) Filed: Aug. 3, 2023

Related U.S. Application Data
(60) Provisional application No. 63/404,670, filed on Sep. 8, 2022.

(51) Int. Cl. E01B 29/05; E01B 29/16

(52) U.S. Cl. CPC E01B 29/05; E01B 29/16

(57) ABSTRACT

A clamp assembly may include a housing that can be positionable alongside an elongated body, one or more clamps that can be pivotally couplable with the housing, and an actuator that may pivot the one or more clamps relative to the housing. The clamps may selectively engage the elongated body to thereby restrict movement of the elongated body relative to the housing.

### CROSS-REFERENCE TO RELATED APPLICATIONS

This application claims priority to U.S. Provisional Application No. 63/404,670 (filed 8 Sep. 2022), the entirety of which is incorporated herein by reference.

### BACKGROUND

### Technical Field

The subject matter described herein relates to a clamp assembly that holds an elongated body in place, such as a clamp assembly that holds rails or rail ribbons during transport for replacing or installing rails of a track.

### Discussion of Art

Rails of a track may be placed onto a surface from onboard a rail car that carries the rails. The rails or rail ribbons may be unloaded from the rail car using a variety of different types of equipment, such as winch and pulley systems, thread boxes having multiple moving or pivoting jaws, etc. The rails or rail ribbons may be carried on a rail car to the location(s) where the rails or rail ribbons are installed to replace or install a track.

The rails or rail ribbons may slide during transport. This sliding can pose safety risks to the vehicles transporting the rails or rail ribbons, as well as to operators of the vehicles. Some vehicles include clamps that attempt to secure the rails or rail ribbons and prevent sliding of the rails or rail ribbons on the vehicle. But these clamps can be complex and require several moving parts. Moreover, many clamps may be needed to prevent sliding of the rail in opposite directions, thereby adding to the cost and complexity of transporting the rails or rail ribbons. A need may exist for clamp assemblies that differ from those that currently are available.

### BRIEF DESCRIPTION

In one example, a clamp assembly may include a housing that can be positionable alongside an elongated body, one or more clamps that can be pivotally couplable with the housing, and an actuator that may pivot the one or more clamps relative to the housing. The clamps may selectively engage the elongated body to thereby restrict movement of the elongated body relative to the housing.

In another example, a clamp assembly may include a housing that can be positioned alongside an elongated body, clamps that may be pivotally coupled with the housing, and biasing elements that may be disposed between the clamps and the housing. The biasing elements may exert forces on the clamps that pivot the clamps toward engagement with the elongated body to restrict movement of the elongated body relative to the housing.

In one example, a clamp assembly may include a first clamp device that can be disposed on a first side of an elongated body, and a second clamp device that can be disposed on a second side of the elongated body that is opposite the first side. Each of the first clamp device and the second clamp device may include a housing, clamps pivotally coupled with the housing, an actuator coupled with the clamps, and biasing members coupled with the housing and the clamps. The biasing members may exert forces on the clamps that pivot the clamps relative to the housing into engagement with the elongated body. The actuator may change length to counteract the forces exerted by the biasing members on the clamps and pivot the clamps away from the elongated body.

### BRIEF DESCRIPTION OF THE DRAWINGS

The subject matter may be understood from reading the following description of non-limiting embodiments, with reference to the attached drawings, wherein below:

FIG. 1 illustrates one example of a clamp system;

FIG. 2 illustrates one example of a vehicle that may include one or more of the clamp systems shown in FIG. 1;

FIG. 3 illustrates a perspective view of one example of a clamp assembly shown in FIG. 1 in an open state or position;

FIG. 4 illustrates a perspective view of the clamp assembly shown in FIG. 3 in a closed state or position;

FIG. 5 illustrates another perspective view of the clamp assembly in the open state or position with a rail or rail ribbon;

FIG. 6 illustrates a top plan view of the clamp assembly in the open state or position with a rail or rail ribbon;

FIG. 7 illustrates an elevational view of the clamp assembly in the open state or position with a rail or rail ribbon;

FIG. 8 illustrates another perspective view of the clamp assembly in the closed state or position with a rail or rail ribbon;

FIG. 9 illustrates a top plan view of the clamp assembly in the closed state or position with a rail or rail ribbon;

FIG. 10 illustrates an elevational view of the clamp assembly in the closed state or position with a rail or rail ribbon;

FIG. 11 illustrates another perspective view of the clamp assembly shown in FIGS. 3 through 10 in a closed or secured position or state, with one example of biasing bodies included in the clamp assembly;

FIG. 12 illustrates the clamps of the clamp assembly shown in FIG. 11 with the housings removed; and

FIG. 13 illustrates the housing of the clamp assembly shown in FIG. 11 with the clamps removed.

### DETAILED DESCRIPTION

Features of the inventive subject matter relate to a clamp assembly that holds an elongated body in place. In one embodiment, a clamp assembly may selectively hold one or more rails or rail ribbons during their transport and ultimate installation for replacing or installing rails of a track. The clamp assembly may include a housing, one or more clamps, and at least one actuator. The housing may be positionable alongside an elongated body, the clamp may pivotally couple with the housing, and the actuator may pivot the clamps relative to the housing. During operation, the clamps may engage the elongated body to restrict movement of the elongated body relative to the housing.

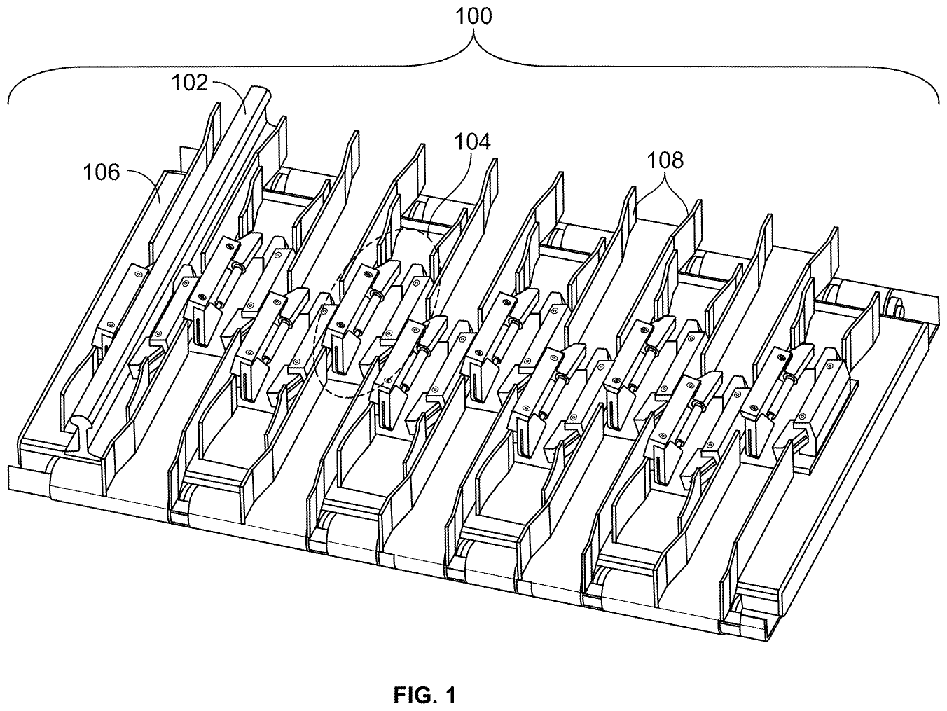

FIG. 1 illustrates one example of a clamp system 100. The clamp system may be disposed onboard a vehicle. Suitable vehicles may include a rail vehicle or rail car, that is transporting rails or rail ribbons 102. While only one rail or rail ribbon is shown in FIG. 1, the clamp system may hold many more rails or rail ribbons. The clamp system may include several clamp assemblies 104 disposed on a bed 106 having several chute walls 108 that define chutes 110 through which the rails or rail ribbons are loaded. The clamp assemblies may be disposed within the chutes such that a rail or rail ribbon in a chute is located between opposing clamp assemblies, as shown in FIG. 1. The clamp assemblies may alternate between open and closed states or positions. FIG. 1 shows the clamp assemblies in the closed state or position.

In one embodiment, the claim assembly may have a default or biased position that is closed, while in other embodiments the default or biased position may be open. In such embodiments, the actuator may be employed to switch the positions from the default to the non-default position. That is, the resting position may be selected to be open or closed so that in the absence of the actuator influence the claim assembly performs a clamping (or un-clamping) role. During operation of a default closed embodiment, the clamp assembly maintains the elongated body in a secure and non-moving condition until the actuator frees it. The actuator may operate responsive to signals provided by a controller (not shown). In another embodiment, the signal may be manually input by an operator.

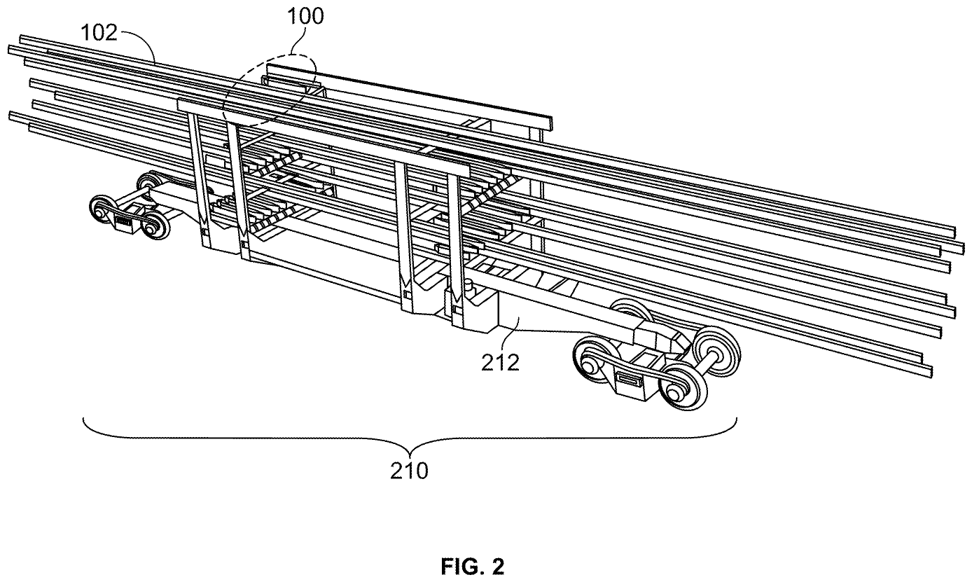

FIG. 2 illustrates one example of a vehicle 210 that may include one or more of the clamp systems shown in FIG. 1. The vehicle is depicted as a rail car that travels along tracks formed from the rails or rail ribbons. The vehicle may include a chassis 212, above which are several of the clamp systems at or near opposite ends of the rails or rail ribbons to clamp and secure the rails or rail ribbons during movement.

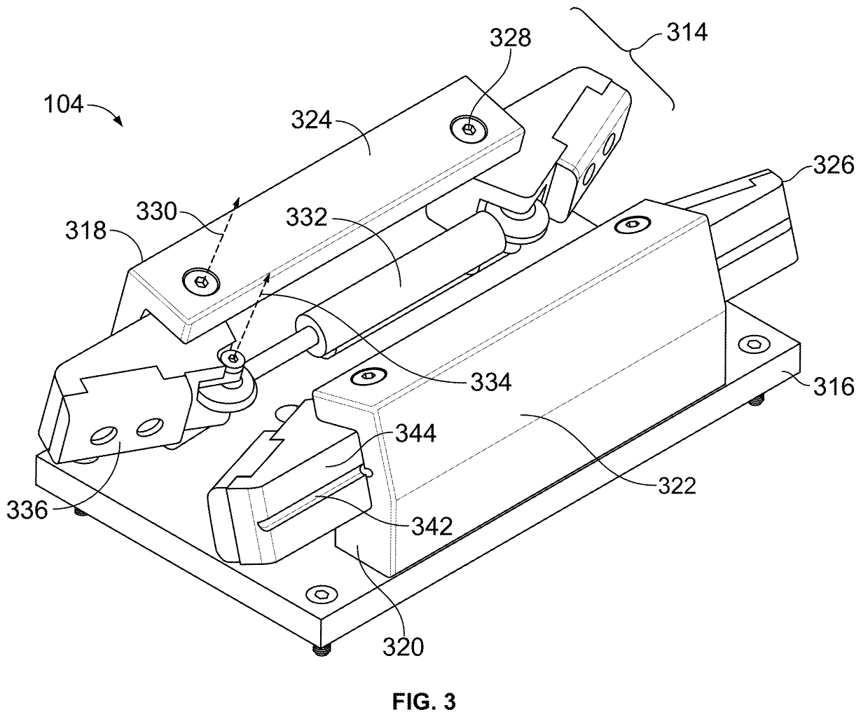

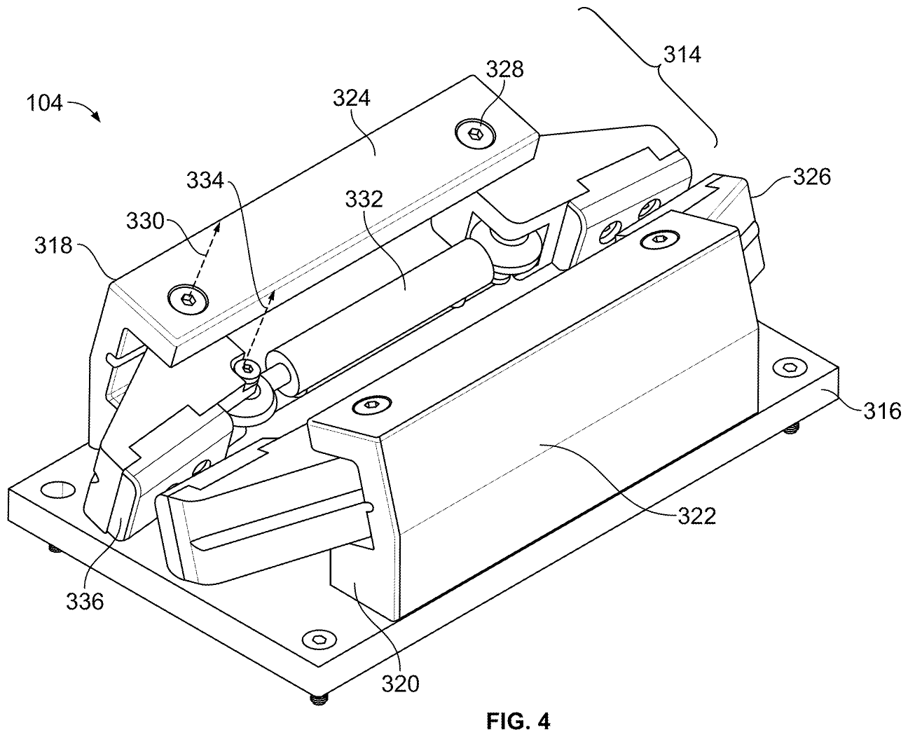

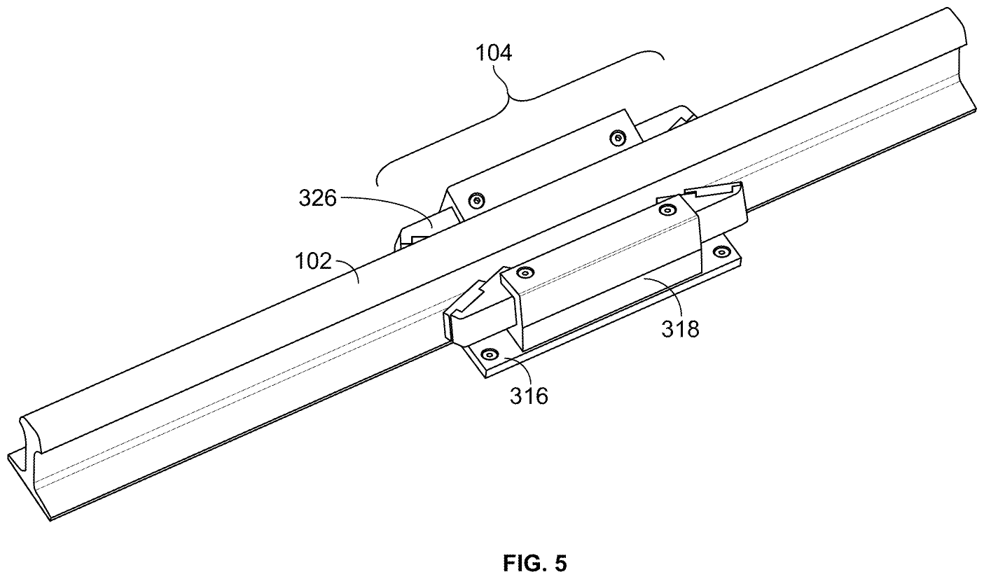

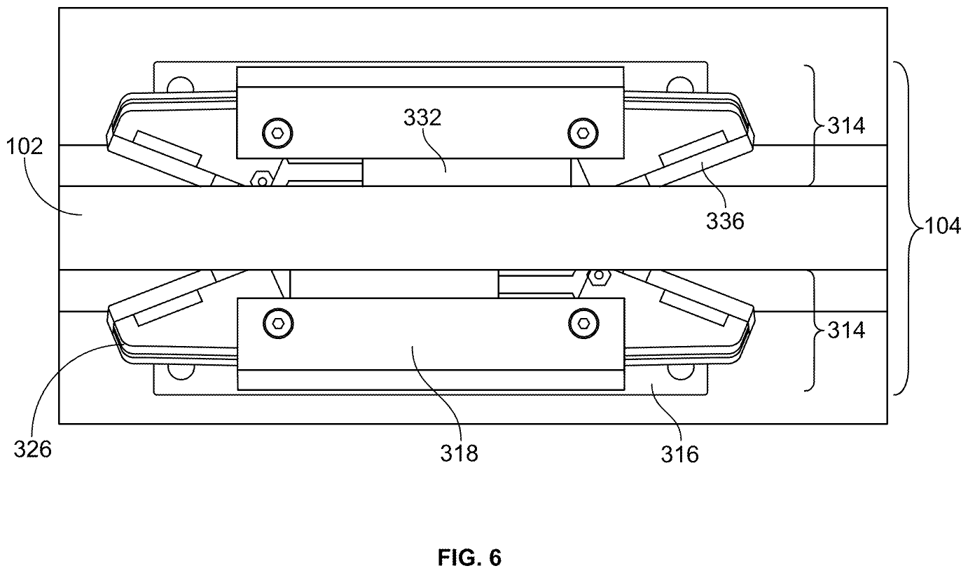

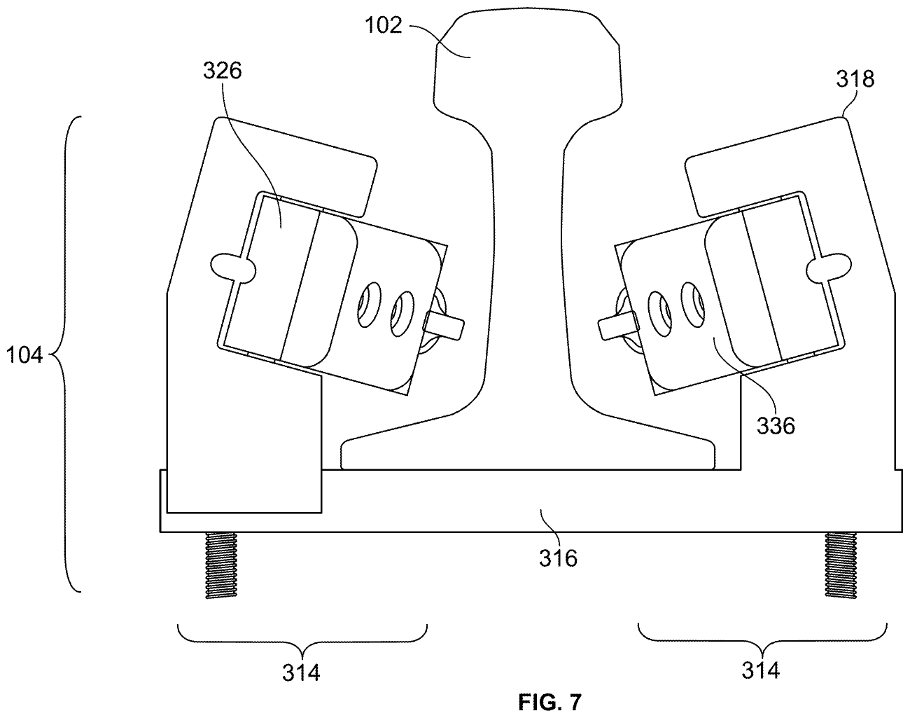

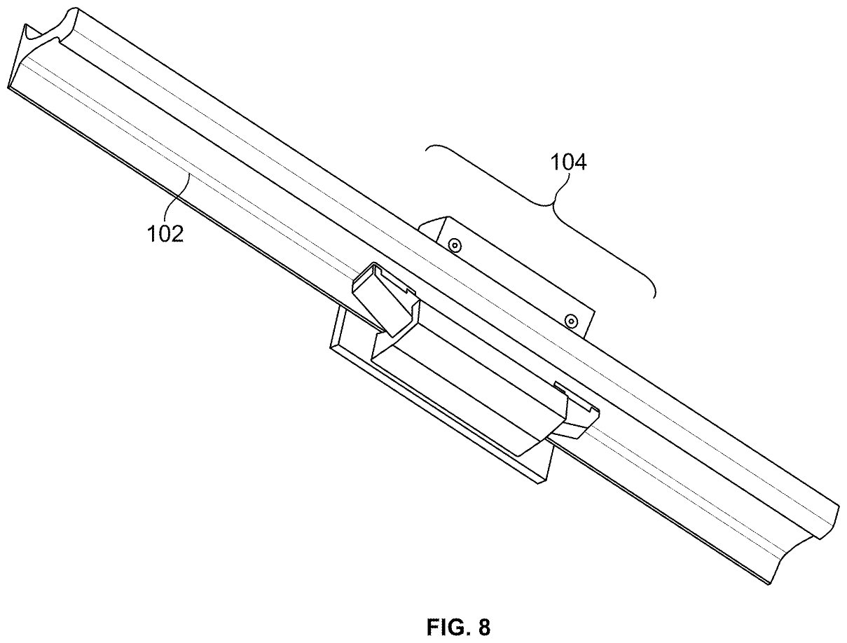

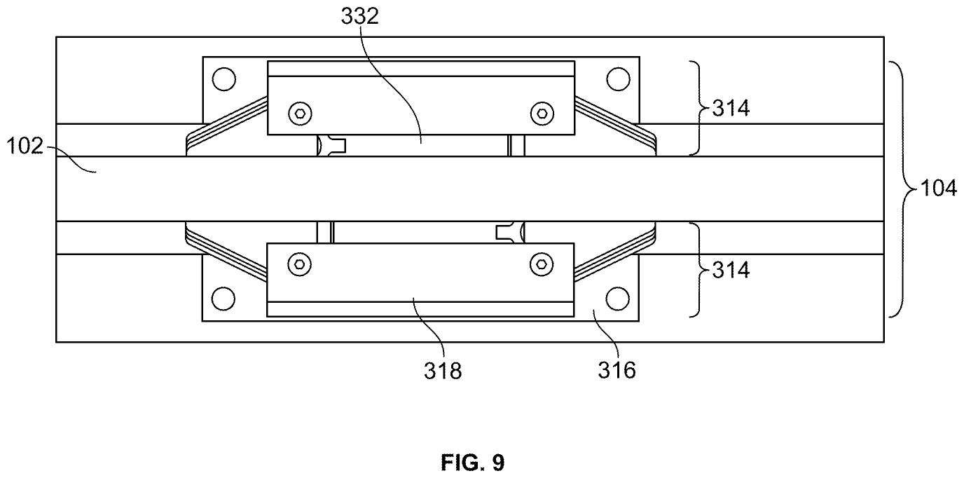

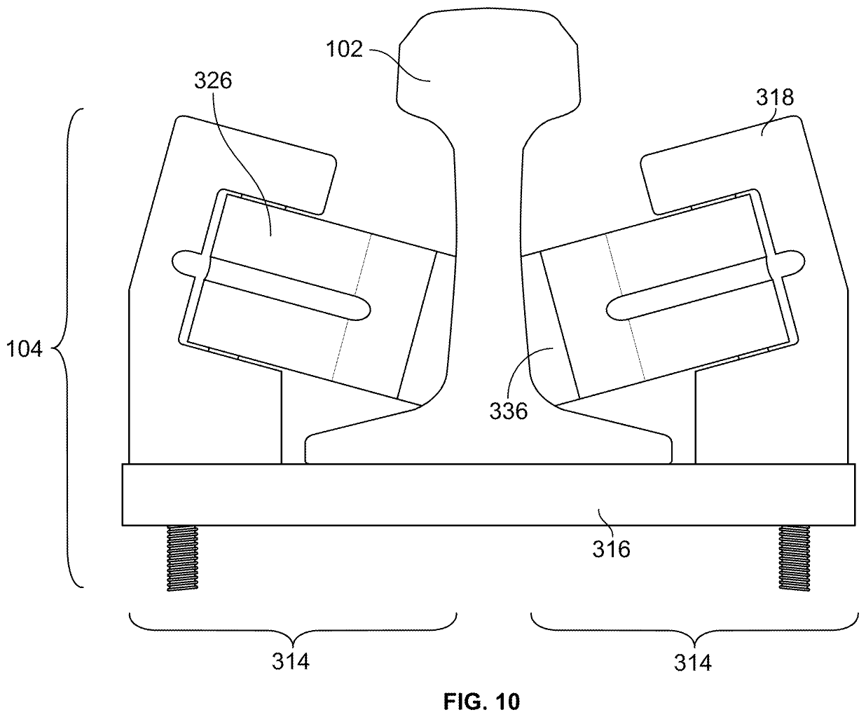

FIG. 3 illustrates a perspective view of one example of the clamp assembly 104 shown in FIG. 1 in an open state or position. FIG. 4 illustrates a perspective view of the clamp assembly shown in FIG. 3 in a closed state or position. FIG. 5 illustrates another perspective view of the clamp assembly in the open state or position with a rail or rail ribbon. FIG. 6 illustrates a top plan view of the clamp assembly in the open state or position with a rail or rail ribbon. FIG. 7 illustrates an elevational view of the clamp assembly in the open state or position with a rail or rail ribbon. FIG. 8 illustrates another perspective view of the clamp assembly in the closed state or position with a rail or rail ribbon. FIG. 9 illustrates a top plan view of the clamp assembly in the closed state or position with a rail or rail ribbon. FIG. 10 illustrates an elevational view of the clamp assembly in the closed state or position with a rail or rail ribbon. In the open state or position, the clamp assembly may disengage from the rail or rail ribbon and, as such, the rail or rail ribbon may move or slide relative to the clamp assembly. In the closed state or position, the clamp assembly may engage with the rail or rail ribbon and, as such, the rail or rail ribbon may be prevented from moving or sliding relative to the clamp assembly.

The clamp assembly may include opposing clamp devices 314 that are coupled with a plate 316. This plate may be coupled with the bed of the clamp system. Each clamp device may include an elongated housing 318. This housing is shown as having a shape of the letter C or U formed by a bottom wall 320 that may be fastened to the plate, a back wall 322, and a top wall 324, with the back wall interconnecting the bottom wall and the top wall. Alternatively, the housing may have a different shape and/or different walls. Each clamp device may include multiple (e.g., two) clamps 326. The clamps may be pivotally mounted in the housing by fasteners 328 such that each clamp may rotate or pivot relative to the housing around or about an axis 330 of the fastener or extending through or along a length of the fastener.

Each clamp may be coupled with an actuator 332. For example, each clamp may be pivotally connected with the actuator in a location that differs from the axis about which the clamp pivots relative to the housing. In the illustrated example, each clamp may be fastened with the actuator by another fastener for pivoting around or about another axis 334. The axis about which the clamp is connected with the actuator may be spaced apart from the axis about which the clamp may connect with the housing. The axis associated with the connection with the actuator can be referred to as an actuator axis, while the other axis can be referred to as a housing axis.

The actuator may be connected with plural clamps. Alternatively, each actuator may be coupled with a single clamp. Suitable actuators may be electric, hydraulic or pneumatic, and may act as a telescoping pole or an extension. If electric, the actuator may be a motor, solenoid, or other electronic device that can move the clamp in response to a signal to do so. In the illustrated example, the actuator of each clamp device can be coupled with two of the clamps. To move the clamps of the same clamp device into an open or released position, the actuator expands in length. This causes the clamps to be pushed away from each other and pivot about the housing axis. This pivoting moves the clamps away from the rail or rail ribbon, as shown in FIGS. 3 and 5 through 7. For example, the actuator may be provided with a fluid to cause the actuator to increase in length, thereby pushing the clamps away from each other and cause the clamps to pivot away from the rail or rail ribbon (about the housing axes). To move the clamps of the same clamp device into a closed or secured position, the actuator may shorten in length. This may cause the clamps to be pulled toward each other and pivot about the housing axis in an opposite direction than when the actuator increased in length. This pivoting may move the clamps toward the rail or rail ribbon, as shown in FIGS. 4 and 8 through 10.

Clamp devices may be positioned on opposite sides of the same rail or rail ribbon. To release the rail or rail ribbon, the actuators of these clamp devices can extend in length and pivot the clamps away from the rail or rail ribbon. To secure the rail or rail ribbon, the actuators may shorten in length and pivot the clamps toward the rail or rail ribbon. The clamps may engage the rail or rail ribbon on opposite sides of the rail or rail ribbon, thereby preventing movement of the rail or rail ribbon in directions extending between the clamp devices. The clamp system may be able to open or close several (or all) clamp devices at once. For example, the actuators of several (or all) clamp devices can be actuated (e.g., lengthened or shortened) at the same time to release or engage multiple rails or rail ribbons at the same time.

The clamps may have grip pads or engagement surfaces 336 that engage the opposite sides of the rail or rail ribbon in the closed or secure state or position. In one embodiment, these engagement surfaces are planar surfaces that engage sides of the rail or rail ribbon, as shown in FIG. 10. Alternatively, a suitable profile for the engagement surfaces may be curved. Suitable materials for the grip pad may include metal, rubber or ceramic. Suitable metal may include brass, copper, tin, and mild steel. In one embodiment, the grip pad may be permanently secured to the contact portion of the claim. Other suitable grip pads may be removably securable to an inner surface of the clamp tip such that the pad is the contact surface with the elongated body, such as the rail. When overly worn or damaged, the grip pad may be replaced with a new grip pad without having to remove and replace the clamp itself. In one embodiment, the grip pad, or if no grip pad then the contact surface of the clamp itself, has a patterned surface to facilitate gripping, such as a metal pad having raised teeth. In one embodiment, the teeth are angled so as to better prevent sliding or movement of the elongate body when the clamp is engaged therewith.

As shown in FIG. 7, the clamps may pivot along the housing axes that are oriented at transverse (e.g., acute) angles with respect to the sides of the rail or rail ribbon. This angle at which the engagement surfaces are disposed relative to the sides of the rail or rail ribbon can assist in the engagement surfaces (or the outer ends of the clamps) biting into or engaging the rails or rail ribbons.

Each clamp device may include multiple clamps on opposite ends of the clamp device. This can provide protection against the rail or rail ribbon from sliding in opposite directions (e.g., along the length of the rail or rail ribbon). Having just one clamp in each clamp device may increase the risk of the rail or rail ribbon sliding relative to the clamp device (e.g., in a direction toward the end of the clamp device that does not have a clamp). Additionally, clamp devices may be disposed on opposite sides of each rail or rail ribbon to provide additional security against the rail or rail ribbon sliding.

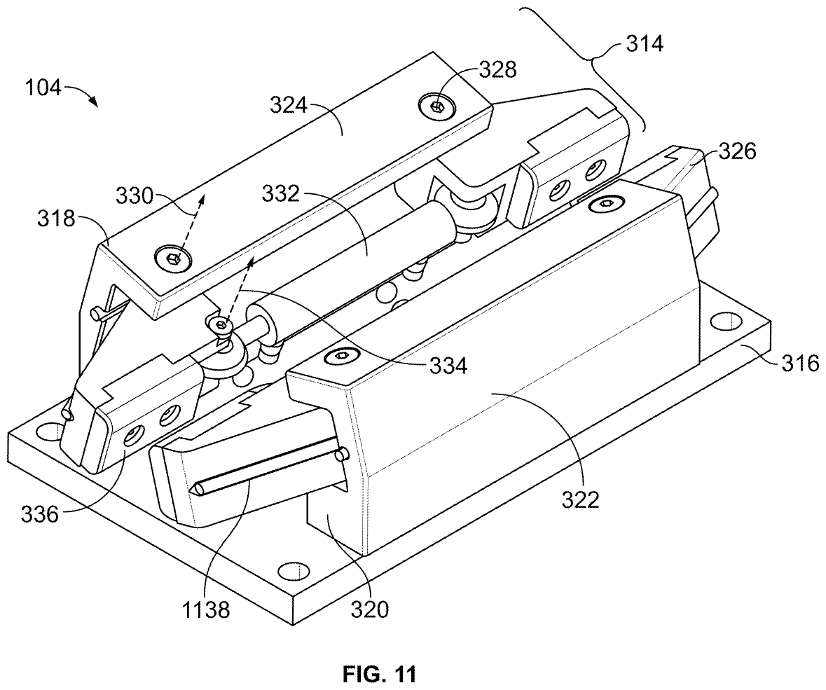

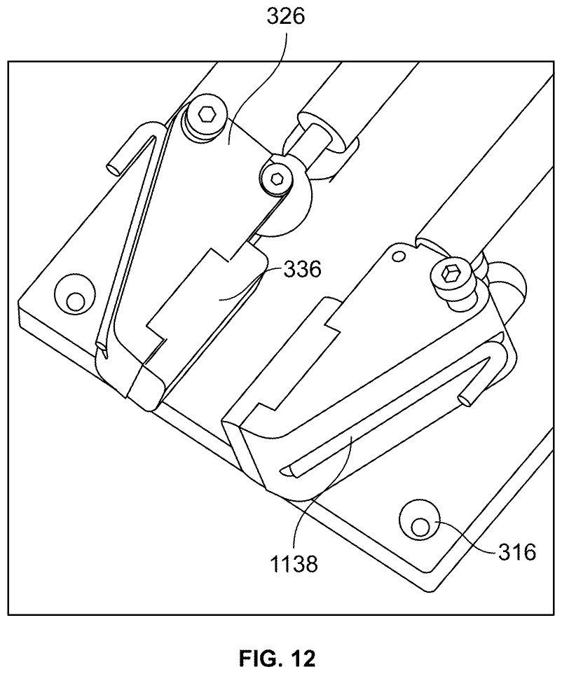

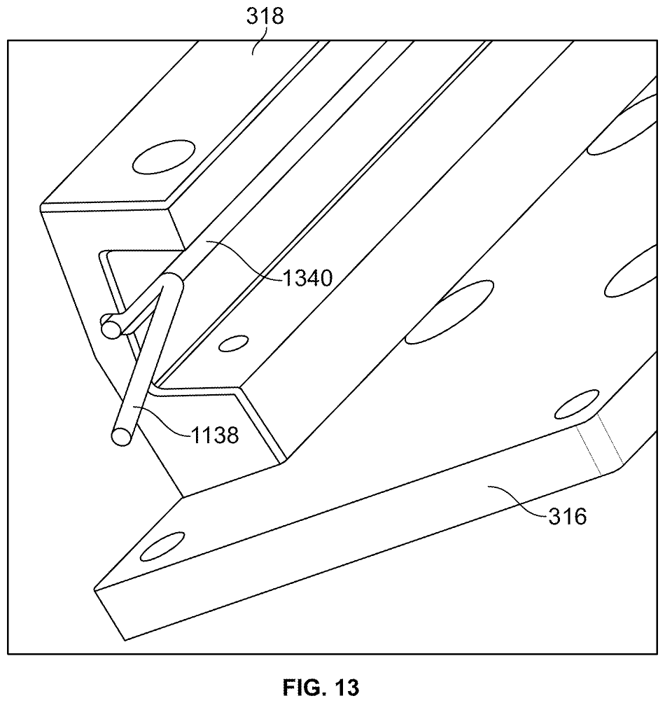

FIG. 11 illustrates another perspective view of the clamp assembly shown in FIGS. 3 through 10 in a closed or secured position or state, one example of biasing bodies 1138 included in the clamp assembly. FIG. 12 illustrates the clamps of the clamp assembly shown in FIG. 11 with the housings removed. FIG. 13 illustrates the housing of the clamp assembly shown in FIG. 11 with the clamps removed. The clamp assembly optionally can include the biasing bodies that bias or push the clamps toward the closed or secured position or state. For example, if the actuators fail, if the actuators are not provided with fluid to lengthen the actuators, etc., the biasing bodies may force the clamps to pivot around or about the housing axes toward the closed or secured position against the rail or rail ribbon. In the situation where there is a failure of the actuator the clamp assembly still does not permit the rail or rail ribbon to slide relative to the clamp assembly.

The biasing bodies may be J-shaped resilient bodies, such as metal J-shaped bodies. One end or segment of the biasing body may be disposed in a channel 1340 inside the back wall of the housing, as shown in FIG. 13. An opposite end or segment of the biasing body may be disposed in a channel 342 along a back side or surface 344 of the clamp, as shown in FIG. 3. This back side or surface may be opposite the engagement surface of the clamp. The biasing body may exert a force that pushes the clamp away from the housing to pivot the clamp toward the rail or rail ribbon. The actuator can operate to generate a counteracting force that overcomes the force exerted by the biasing body to move the clamps to the open position. This counteracting force can push the two segments of the biasing body toward each other (e.g., to compress the J-shaped body). Once the actuator no longer provides this counteracting force, the biasing bodies can force the clamps back to the closed or secured position as a default position of the clamps.

In one embodiment, a method for securing elongated bodies is provided. This method may include, at a first step, placing an elongated body, such as a rail or rail ribbon, aside or between clamp assemblies. At a second step, clamps of the clamp assemblies are actuated to pivot and move toward the elongated body to secure the elongated body. When the elongated body is ready to be removed (e.g., for installation or replacement of a rail), the clamps are actuated or released to pivot and move away from the elongated body to release the elongated body. In one embodiment, the controller signals the actuator to move the claim assembly. The controller may coordinate the open/closed state of the clamp assembly with, for example, the motion or speed of the vehicle, the location of the vehicle (or some part thereof) relative to a work site location (such as where a rail placement is needed), and the like. The controller may signal for a clamp assembly on one side of the vehicle or another to actuate, and this may be done simultaneously (or asynchronously) as determined for a particular operation.

While one or more embodiments of the subject matter described herein has been explained in terms of rails and rail vehicles, not all embodiments are limited to rails and rail vehicles. For example, the clamp assembly and system may be used to secure other elongated bodies, such as pipes, beams, or the like, on floors, walls, work benches, tables, or the like.

In one example, a clamp assembly may include a housing that can be positionable alongside an elongated body, one or more clamps that can be pivotally couplable with the housing, and an actuator that may pivot the one or more clamps relative to the housing. The clamps may selectively engage the elongated body to thereby restrict movement of the elongated body relative to the housing.

The clamps may be disposed at opposite ends of the housing. The clamps may pivot toward each other as the clamps pivot toward the elongated body. The actuator may pivot the clamps away from the elongated body to release the elongated body by increasing a length of the actuator. The clamps may include engagement surfaces formed from a different material than the elongated body.

The assembly also may include biasing elements disposed between the clamps and the housing. The biasing elements may exert forces on the clamps that pivot the clamps toward engagement with the elongated body. The clamps may be connected with the actuator such that the clamps can pivot relative to the housing around a housing axis and pivot relative to the actuator around an actuator axis that is spaced apart from the housing axis.

The clamps may move toward and engage one or more of a rail or a rail ribbon as the elongated body. The clamps may pivot toward the elongated body around axes that are transversely oriented relative to sides of the elongated body that are engaged by the clamps. The housing, the clamps, and the actuator may be included in a first clamp device on one side of the elongated body, and the assembly may also include a second clamp device on an opposite side of the elongated body.

In another example, a clamp assembly may include a housing that can be positioned alongside an elongated body, clamps that may be pivotally coupled with the housing, and biasing elements that may be disposed between the clamps and the housing. The biasing elements may exert forces on the clamps that pivot the clamps toward engagement with the elongated body to restrict movement of the elongated body relative to the housing.

The assembly also may include an actuator that can pivot the clamps away from engagement with the elongated body to allow the movement of the elongated body relative to the housing. The actuator may pivot the clamps away from the elongated body to release the elongated body by increasing a length of the actuator. The clamps may be connected with the actuator such that the clamps pivot relative to the housing around a housing axis and pivot relative to the actuator around an actuator axis that is spaced apart from the housing axis.

The clamps may be disposed at opposite ends of the housing and the clamps pivot toward each other as the clamps pivot toward the elongated body. The clamps may include engagement surfaces formed from a different material than the elongated body. The biasing elements may exert forces on the clamps that pivot the clamps toward engagement with the elongated body. The clamps may move toward and engage one or more of a rail or a rail ribbon as the elongated body. The clamps may pivot toward the elongated body around axes that are transversely oriented relative to sides of the elongated body that are engaged by the clamps.

In one example, a clamp assembly may include a first clamp device that can be disposed on a first side of an elongated body, and a second clamp device that can be disposed on a second side of the elongated body that is opposite the first side. Each of the first clamp device and the second clamp device may include a housing, clamps pivotally coupled with the housing, an actuator coupled with the clamps, and biasing members coupled with the housing and the clamps. The biasing members may exert forces on the clamps that pivot the clamps relative to the housing into engagement with the elongated body. The actuator may change length to counteract the forces exerted by the biasing members on the clamps and pivot the clamps away from the elongated body.

Use of phrases such as “one or more of . . . and,” “one or more of . . . or,” “at least one of . . . and,” and “at least one of . . . or” are meant to encompass including only a single one of the items used in connection with the phrase, at least one of each one of the items used in connection with the phrase, or multiple ones of any or each of the items used in connection with the phrase. For example, “one or more of A, B, and C,” “one or more of A, B, or C,” “at least one of A, B, and C,” and “at least one of A, B, or C” each can mean (1) at least one A, (2) at least one B, (3) at least one C, (4) at least one A and at least one B, (5) at least one A, at least one B, and at least one C, (6) at least one B and at least one C, or (7) at least one A and at least one C.

As used herein, an element or step recited in the singular and preceded with the word “a” or “an” do not exclude the plural of said elements or operations, unless such exclusion is explicitly stated. Furthermore, references to “one embodiment” of the invention do not exclude the existence of additional embodiments that incorporate the recited features. Moreover, unless explicitly stated to the contrary, embodiments “comprising,” “comprises,” “including,” “includes,” “having,” or “has” an element or a plurality of elements having a particular property may include additional such elements not having that property. In the appended claims, the terms “including” and “in which” are used as the plain-English equivalents of the respective terms “comprising” and “wherein.” Moreover, in the following claims, the terms “first,” “second,” and “third,” etc. are used merely as labels, and do not impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function devoid of further structure.

The above description is illustrative, and not restrictive. For example, the above-described embodiments (and/or aspects thereof) may be used in combination with each other. In addition, many modifications may be made to adapt a particular situation or material to the teachings of the subject matter without departing from its scope. While the dimensions and types of materials described herein define the parameters of the subject matter, they are exemplary embodiments. Other embodiments will be apparent to one of ordinary skill in the art upon reviewing the above description. The scope of the subject matter should, therefore, be determined with reference to the appended claims, along with the full scope of equivalents to which such claims are entitled.

This written description uses examples to disclose several embodiments of the subject matter, including the best mode, and to enable one of ordinary skill in the art to practice the embodiments of subject matter, including making and using any devices or systems and performing any incorporated methods. The patentable scope of the subject matter is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

What is claimed is:

1. A clamp assembly, comprising:
a housing configured to be positionable alongside an elongated body;
one or more clamps pivotally couplable with the housing; and
an actuator configured to pivot the one or more clamps relative to the housing, the clamps being configured to selectively engage the elongated body, and thereby to restrict movement of the elongated body relative to the housing.

2. The clamp assembly of claim 1, wherein the clamps are disposed at opposite ends of the housing and the clamps pivot toward each other as the clamps pivot toward the elongated body.

3. The clamp assembly of claim 1, wherein the actuator is configured to pivot the clamps away from the elongated body to release the elongated body by increasing a length of the actuator.

4. The clamp assembly of claim 1, wherein the clamps include engagement surfaces formed from a different material than the elongated body.

5. The clamp assembly of claim 1, further comprising biasing elements disposed between the clamps and the housing, the biasing elements exerting forces on the clamps that pivot the clamps toward engagement with the elongated body.

6. The clamp assembly of claim 1, wherein the clamps are connected with the actuator such that the clamps pivot relative to the housing around a housing axis and pivot relative to the actuator around an actuator axis that is spaced apart from the housing axis.

7. The clamp assembly of claim 1, wherein the clamps are configured to move toward and engage one or more of a rail or a rail ribbon as the elongated body.

8. The clamp assembly of claim 1, wherein the clamps are configured to pivot toward the elongated body around axes that are transversely oriented relative to sides of the elongated body that are engaged by the clamps.

9. The clamp assembly of claim 1, wherein the housing, the clamps, and the actuator are included in a first clamp device on one side of the elongated body, and further comprising a second clamp device on an opposite side of the elongated body.

10. A clamp assembly, comprising:
a housing configured to be positioned alongside an elongated body;
clamps pivotally coupled with the housing; and
biasing elements disposed between the clamps and the housing, the biasing elements exerting forces on the clamps that pivot the clamps toward engagement with the elongated body to restrict movement of the elongated body relative to the housing.

11. The clamp assembly of claim 10, further comprising an actuator configured to pivot the clamps away from engagement with the elongated body to allow the movement of the elongated body relative to the housing.

12. The clamp assembly of claim 11, wherein the actuator is configured to pivot the clamps away from the elongated body to release the elongated body by increasing a length of the actuator.

13. The clamp assembly of claim 11, wherein the clamps are connected with the actuator such that the clamps pivot relative to the housing around a housing axis and pivot relative to the actuator around an actuator axis that is spaced apart from the housing axis.

14. The clamp assembly of claim 10, wherein the clamps are disposed at opposite ends of the housing and the clamps pivot toward each other as the clamps pivot toward the elongated body.

15. The clamp assembly of claim 10, wherein the clamps include engagement surfaces formed from a different material than the elongated body.

16. The clamp assembly of claim 10, wherein the biasing elements are configured to exert forces on the clamps that pivot the clamps toward engagement with the elongated body.

17. The clamp assembly of claim 10, wherein the clamps are configured to move toward and engage one or more of a rail or a rail ribbon as the elongated body.

18. The clamp assembly of claim 10, wherein the clamps are configured to pivot toward the elongated body around axes that are transversely oriented relative to sides of the elongated body that are engaged by the clamps.

19. A clamp assembly comprising:
a first clamp device configured to be disposed on a first side of an elongated body; and
a second clamp device configured to be disposed on a second side of the elongated body that is opposite the first side, each of the first clamp device and the second clamp device including:
a housing;
clamps pivotally coupled with the housing;
an actuator coupled with the clamps; and
biasing members coupled with the housing and the clamps, the biasing members configured to exert forces on the clamps that move the clamps relative to the housing into engagement with the elongated body, the actuator configured to change size to counteract the forces exerted by the biasing members on the clamps and move the clamps away from the elongated body.

20. The clamp assembly of claim 19, wherein the actuator is configured to extend in length to counteract the forces exerted by the biasing members on the clamps.
